(19) United States
(12) Patent Application Publication
(10) Pub. No.: US 2024/0001355 A1
(43) Pub. Date: Jan. 4, 2024

(54) SOLID CATALYST COMPOSITION FOR ORGANIC WASTE TREATMENT, MANUFACTURING METHOD THEREOF AND USE THEREOF

(71) Applicant: Tetanti AgriBiotech Inc., Taichung City (TW)

(72) Inventors: Chiu Chung YOUNG, Taichung City (TW); Li-Sen YOUNG, Taichung City (TW)

(73) Assignee: Tetanti AgriBiotech Inc., Taichung City (TW)

(21) Appl. No.: 18/338,927

(22) Filed: Jun. 21, 2023

(30) Foreign Application Priority Data
Jul. 4, 2022 (TW) 111124971

(51) Int. Cl. B01J 35/00; B01J 37/04; B01J 37/02; B01J 35/02; B01J 31/00

(52) U.S. Cl. CPC B01J 35/0006; B01J 37/04; B01J 37/0213; B01J 37/0236; B01J 37/0209; B01J 35/02; B01J 31/003

(57) ABSTRACT

The present disclosure provides a solid catalyst composition for organic waste treatment, manufacturing method thereof and use thereof. With the solid catalyst composition comprising a catalyst liquid, an inorganic mineral carrier, a biochar carrier and an organic carrier, the maturing efficiency of the organics can be improved, and a high-quality organic fertilizer can be obtained.

This application claims priority under 35 U.S.C. § 119 to Taiwanese Patent Application No. 111124971, filed Jul. 4, 2022, the entirety of which is incorporated by reference herein.

### BACKGROUND OF THE INVENTION

### Field of the Invention

The present disclosure relates to a solid catalyst composition, a manufacture method thereof and a use thereof. Specifically, the present disclosure relates to a solid catalyst composition for organic waste treatment, a manufacture method thereof and a use thereof.

### Description of the Prior Art

The production of conventional organic fertilizers is mainly from the treatment of organic wastes including animals, plants, microbial residues or animal excrement. Traditionally, the “composting method” is used. The composting method relies on the “microbial method” of nature or inoculation. After mixing the biological residues with microorganisms, it is left for several months to achieve the maturing of the organic matter, thereby making the compost. “Microbial method” is the decomposition phenomenon of organic waste using “living” microorganisms.

The composting method of microorganisms has many shortcomings. The microorganisms need to consume the carbon source and energy of the organic waste for reproduction. The time to make compost is long, the required composting space is large, and the odor, waste water, carbon dioxide, methane, denitrification, ammonia volatilization and other pollution problems are produced. There has been no major change in the composting methods in recent years, and innovation and improvement for the composting process is needed.

In view of the shortcomings of the microbial composting method, catalyst composting methods have been developed in recent years to reduce its negative effects. However, catalysts are usually stored in a liquid form, which is inconvenient to preserve, susceptible to contamination, and limited in usage.

Accordingly, there is a need for a composition that can facilitate storage and accelerate composting in an efficient and low-polluting manner, a manufacturing method of the composition, and a use method of the composition.

### SUMMARY OF THE INVENTION

According to the above object, the present disclosure provides a solid catalyst composition for organic waste treatment, which comprises: a catalyst liquid; an inorganic mineral carrier; a biochar carrier; and an organic carrier, wherein a weight ratio of the catalyst liquid to a sum of the inorganic mineral carrier, the biochar carrier and the organic carrier is 1:10 to 55, and a weight ratio of the inorganic mineral carrier, the biochar carrier and the organic carrier is 10 to 20:5 to 25:60 to 75.

Preferably, the weight ratio of the catalyst liquid to the sum of the inorganic mineral carrier, the biochar carrier and the organic carrier is 1:50.

Preferably, the weight ratio of the inorganic mineral carrier, the biochar carrier and the organic carrier is 15:15:70.

Preferably, the catalyst liquid comprises at least one of a hydrolase, an oxidoreductase, a transferase, a synthetase, a lyase, a protease, a lipase and a cellulase.

Preferably, the inorganic mineral carrier comprises at least one of amorphous minerals, crystalline 1:1 layered minerals and crystalline 2:1 layered minerals.

Preferably, the biochar carrier comprises at least one of bamboo charcoal, wood charcoal and activated charcoal.

Preferably, the organic carrier comprises at least one of dregs, humic acid, fulvic acid, peat soil powder and starchiness.

Preferably, a moisture content of the solid catalyst composition is 10 to 25% by weight.

According to another object of the present disclosure, a manufacturing method of a solid catalyst composition for organic waste treatment is further provided. The method comprises a catalyst liquid concentration step, which dewaters and concentrates the catalyst liquid to obtain a concentrated catalyst liquid; an inorganic mineral carrier mixing step, which adds 10 to 20 parts by weight of an inorganic mineral; a biochar carrier mixing step, which adds 5 to 25 parts by weight of a biochar carrier; and an organic carrier mixing step, which adds 60 to 75 parts by weight of an organic carrier to obtain a solid catalyst composition.

Preferably, the manufacturing method further comprises a water content control step after the organic carrier mixing step, which controls a weight percentage of water in the solid catalyst composition to 10 to 25%.

According to a further object of the present disclosure, a use of a solid catalyst composition for organic waste treatment in production of an organic fertilizer is further provided. The use comprises providing an organic waste raw material; mixing the organic waste raw material with the solid catalyst composition described above to obtain a mixture; heating up the mixture to 75 to 85° C. to perform a reaction to obtain the organic fertilizer.

Preferably, a weight ratio of the solid catalyst composition to the organic waste raw material is 1:10 to 55.

Preferably, the reaction is carried out for 1 to 3.5 hrs.

With the above aspects, the solid catalyst composition, its manufacturing method and its use according to the embodiments of the present disclosure have at least the following advantages.

(1) The solid catalyst composition according to the present disclosure can be used to accelerate the maturing of organic matter.

(2) Through the manufacturing method of the solid catalyst composition provided by the disclosure, the solid catalyst composition that is convenient for preservation can be manufactured. The solid catalyst composition is not easily polluted by miscellaneous bacteria, and the preservation time of the structure and function of the catalyst is longer, making it more convenient to use.

(3) Through the rapid treatment of the solid catalyst composition according to the embodiment of the present disclosure, an organic fertilizer that is superior to those obtained from composting for 3 months can be produced in a short time.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flowchart of a manufacturing method of a solid catalyst composition according to an embodiment of the present disclosure.

FIG. 2 is a comparison result of maturity obtained from filter paper chromatography of different organic matter applied with the compost made through either the rapid treatment of the solid catalyst composition according to the embodiment of the present disclosure and the traditional manner.

FIG. 3 shows the growth results of field leaf lettuces growing for 36 days that are applied with either the organic fertilizer obtained by rapid treatment with the solid catalyst composition according to the embodiment of the present disclosure or the traditional compost.

### DETAILED DESCRIPTION OF THE EMBODIMENTS

The embodiments are described in detail below with reference to the related drawings. However, these embodiments can be implemented in different forms, but are not the only form of implementing or utilizing the specific embodiments of the disclosure claimed in this application, and therefore should not be construed as a limitation on the above-mentioned embodiments. The features of various specific embodiments as well as method steps and sequences for constructing and operating these specific embodiments are encompassed in the detailed description. However, other embodiments may also be utilized to achieve the same or equivalent function and sequence of steps. Rather, these embodiments are provided so that this specification can be thoroughly and completely disclosed, and will fully convey the spirit of the disclosure to people having ordinary skill in the art to which the disclosure pertains. Similar reference numerals in the figures refer to similar elements. In the following description, well-known functions or structures will not be described in detail so as not to repeat unnecessary details in the embodiments.

Unless otherwise defined, all technical phrases and terms used herein have the same meaning as commonly understood by people having ordinary skill in the art to which this disclosure pertains. In case of conflict, the present specification including the definitions shall prevail.

Without conflicting with the context, the singular nouns used in this specification cover the plural form of the noun; and the plural nouns used also cover the singular form of the noun. In addition, in the specification and the claims, expressions such as “at least one” and “one or more” have the same meaning, and both mean that one, two, three or more are included.

Notwithstanding that the numerical ranges and parameters setting forth the broad scope of the disclosure are approximations, the related numerical values in the specific examples have been presented as precisely as possible. However, any numerical value inherently and inevitably contains the standard deviation resulting from individual testing methods. As used herein, “about” generally means that the actual value is within plus or minus 10%, 5%, 1% or 0.5% of a particular value or range. Alternatively, the word “about” means that the actual value lies within an acceptable standard error of the mean, as considered by people having ordinary skill in the art to which this disclosure pertains. Except in the examples, or unless expressly stated otherwise, all ranges, quantities, values and percentages used herein (e.g., to describe material amounts, time periods, temperatures, operating conditions, quantitative ratios, and the like) are understood to be modified by “about”. Therefore, unless otherwise stated to the contrary, the numerical parameters disclosed in this specification and the claims are all approximate numerical values, which can be changed as required. At a minimum, these numerical parameters should be construed to mean the number of significant digits indicated and the numerical values obtained by applying ordinary rounding. Numerical ranges are expressed herein as being from one endpoint to the other endpoint or between the endpoints; and unless otherwise indicated, the numerical ranges recited herein are inclusive of the endpoints.

The solid catalyst composition according to the embodiment of the present disclosure comprises a catalyst liquid, an inorganic mineral carrier, a biochar carrier and an organic carrier. The weight ratio of the catalyst liquid to the sum of the inorganic mineral carrier, the biochar carrier and the organic carrier is 1:10 to 55, preferably 1:50. The weight ratio of the inorganic mineral carrier, the biochar carrier and the organic carrier is 10 to 20:5 to 25:60 to 75, and preferably, the weight ratio of the inorganic mineral carrier, the biochar carrier and the organic carrier is 15:15:70.

In the solid catalyst composition according to the embodiment of the present disclosure, the catalyst liquid comprises at least one of hydrolases, oxidoreductases, transferases, synthetases, lyases, proteases, lipases and cellulases, preferably hydrolases. With the catalyst contained in the solid catalyst composition, the maturing of the organic matter can be accelerated more directly, the time for making the organic matter into an organic fertilizer can be shortened, and a more uniform and effective organic fertilizer can be obtained.

The aforementioned inorganic mineral carrier may comprise at least one of amorphous minerals, crystalline 1:1 layered minerals, and crystalline 2:1 layered minerals. The amorphous minerals include, but are not limited to: allophane, imogolite, amorphous aluminosilicate, pozzolan, vitreous stone weathered matter, and the like. The crystallized 1:1 layered minerals include, but are not limited to, kaolinite powder, perlite powder, dickite powder, halloysite powder, and the like. The crystalline 2:1 layered minerals include but are not limited to: illite powder, talc powder, palygorskite powder, montmorillonite powder, beidellite powder, pyrophyllite powder, vermiculite powder, nontronite powder, saponite powder, hectorite powder, sepiolite powder, chlorite powder, mica powder, etc. By using inorganic minerals as a carrier, the catalyst can be immobilized on the carrier and thus exists in a solid form.

The aforementioned biochar carrier may comprise activated charcoal, bamboo charcoal, wood charcoal or other types of biochar. By virtue of the porous nature of biochar, the catalyst can be retained inside the biochar and present in a solid form, and preserves its properties.

The aforementioned organic carrier may comprise dregs, humic acid, fulvic acid, peat soil powder, starchiness or a mixture thereof, preferably peat soil powder. The catalyst can attach to organic matter, which acts as a support, thereby allowing the catalyst to exist in solid form.

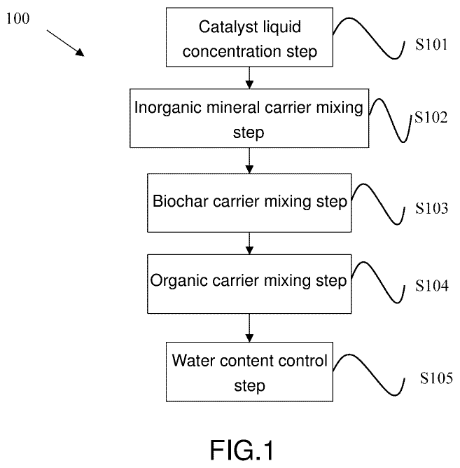

Next, please refer to FIG. 1. FIG. 1 is a flowchart of a manufacturing method 100 of a solid catalyst composition according to an embodiment of the present disclosure.

The manufacturing method 100 of a solid catalyst composition according to an embodiment of the present disclosure includes a catalyst liquid concentration step S101, an inorganic mineral carrier mixing step S102, a biochar carrier mixing step S103, an organic carrier mixing step S104 and a water control step S105.

In the catalyst liquid concentration step S101, in order to increase the catalyst concentration of the solid catalyst product, the catalyst liquid will be concentrated by way of centrifugation and removing the supernatant. Alternatively, filtration can be carried out through a membrane, and the filtrate is concentrated and preserved in dilute glycerol-mannitol-carboxymethyl cellulose solution (2% glycerol, 1% mannitol, 1% carboxymethyl cellulose). The concentrated catalyst can be added with inorganic mineral carrier, biochar carrier and organic carrier according to different requirements to manufacture organic fertilizers having different components.

In the inorganic mineral carrier mixing step S102, in order to make the catalyst adhere to the inorganic mineral carrier to fix it, 10 to 20 parts by weight of the inorganic mineral carrier are added to 2 to 10 parts by weight of the concentrated catalyst liquid. The inorganic mineral carrier may contain amorphous minerals, crystalline 1:1 layered minerals, crystalline 2:1 layered minerals or mixtures thereof, preferably crystalline 2:1 layered minerals. The crystallized 2:1 layered minerals have weak interlayer bonding force, and water molecules and ions can easily enter the interlayers to make the crystallized 2:1 layered minerals peel off into individual flakes, thus greatly increasing the effective specific surface area, which in turn enables more catalysts to be attached.

In the biochar carrier mixing step S103, in order to make the attached catalyst more stable, 5 to 25 parts by weight of the biochar carrier, preferably 15 parts by weight of the biochar carrier, is added. The biochar carrier can be activated charcoal, bamboo charcoal, wood charcoal or other types of biochar, preferably activated charcoal with more pores. Biochar with more pores can allow better adhesion of catalysts and further improve the efficiency of maturing. In the present disclosure, the biochar carriers can be used alone or in combination of two or more.

In the organic carrier mixing step S104, 60 to 75 parts by weight of the organic carrier, preferably 70 parts by weight of the organic carrier, can be added. The organic carrier may comprise dregs, humic acid, fulvic acid, peat soil powder, starchiness or mixtures thereof, preferably peat soil powder. By adding the organic carrier, the catalyst can be attached more stably and has the function of water absorption.

In the water control step S105, the weight percentage of water in the generated solid catalyst composition is controlled to 10 to 25%, preferably 15%. The means of controlling water is not limited, and may include air evacuation drying and freeze drying, preferably freeze drying. The solid catalyst composition with controlled water content can be more convenient to store and have improved shelf life.

According to an embodiment of the present disclosure, a solid catalyst composition for organic waste treatment is provided for the use in organic fertilizer manufacturing. In the process of using the solid catalyst composition to manufacture organic fertilizers, the step of crushing organic waste raw materials is included. The smaller the size after crushing, the more conducive to the manufacture of organic fertilizers. It can be crushed to 2 cm or less, preferably to 1 cm or less, most preferably to 0.5 cm or less. Next, the crushed organic waste raw materials are put into the reaction equipment, and an appropriate amount of water is added to achieve a weight percentage of the water content of 40 to 60%, preferably 50%. Afterwards, the solid catalyst composition is added in a weight percentage of 2 to 10%, preferably 2%, as compared to the organic waste raw material. Next, it is fully stirred and mixed, the heater is turned on to make the temperature in the reaction equipment rise to 75 to and the reaction is carried out for 1 to 3.5 hours, preferably 3 hours, so as to obtain a fast-maturing organic fertilizer.

The solid catalyst composition of the present disclosure, its manufacturing method and its use will be described below through specific examples.

### Example 1

Manufacturing of Solid Catalyst Composition

In this example, the solid catalyst composition was produced by the following method.

1. The catalyst liquid concentration step increased the catalyst concentration of the solid catalyst product. The catalyst solution was concentrated by shrinking and centrifugal. A preferably lower cost method could use the membrane filtration method, and the filtered liquid was concentrated and preserved in dilute glycerin-mannitol-carboxymethyl cellulose liquid (2% glycerol, 1% mannitol, 1% carboxymethyl cellulose). Then the “individual concentrated catalyst liquid” was mixed according to the needs of different organic waste raw materials for use in the solid catalyst process. Here, “individual concentrated catalyst liquid” refers to the concentrated catalyst liquid made of different catalysts selected according to different needs. The following inorganic mineral carrier, biochar carrier and organic carrier were added into the mixing container in sequence (hereinafter the total carrier amount refers to the dry materials calculated as 100 parts by weight). The catalyst could be the hydrolase, oxidoreductase, transferase, synthetase, lyase, protease, lipase or cellulase, and was the hydrolase in this example.

2. In the inorganic mineral carrier mixing step, the structure of the immobilized catalyst was attached to the inorganic mineral, and the concentrated catalyst liquid was added to 15 parts by weight of the inorganic mineral carrier.

3. In the biochar carrier mixing step, 15 parts by weight of activated charcoal was added to make the structure of the immobilized catalyst attach to the biochar carrier more stably.

4. In the organic carrier mixing step, 70 parts by weight of peat soil powder was added to make the structure of the immobilized catalyst attach to the biochar carrier more stably and assist in absorbing water.

5. In the water content control step, the water content of the solid catalyst composition was controlled to 15% by weight through pumping or freeze-drying.

By the above-mentioned manufacturing method, the solid catalyst composition according to the embodiment of the present disclosure can be obtained.

Comparative Analysis of Solid Catalyst Rapid Treatment and Composting

The following examples are to understand the difference in efficacy between “catalyst quick” treatment for 3 hours and “composting” treatment for 3 months to make organic fertilizer products, and to compare the degree of maturity, safety and effectiveness of crop growth. Among them, the maturity index was analyzed by seed germination biological analysis and filter paper chromatography, the inspection and analysis of Salmonella was chosen for the safety index, and the field experiments was chosen for the effect index of crop growth. The analysis results are compared and explained as follows:

### Example 2

Solid Catalyst Rapid Treatment and Composting Method

In order to prove that the effect of the solid catalyst of the present disclosure on the rapid treatment of organic waste for 3 hours can replace the method of traditional composting for 3 months, the solid catalyst rapid treatment of organic waste and the traditional composting treatment were carried out for further comparative analysis. The following illustrates the process of catalyst rapid treatment and traditional composting to make organic fertilizer:

1. Organic waste raw material: the present embodiment chose common broiler manure (containing 50% (V/V) rice husk), pig manure, kitchen waste and litter (1:2, v/v) as materials for treatment and verification.

2. The implementation of the method of the solid catalyst rapid treatment of the present disclosure and the traditional composting treatment for making the organic waste into organic fertilizers are illustrated as follows:

(1) Method of “Solid Catalyst Rapid Treatment” to Organic Waste for Making Organic Fertilizer

First, the organic waste raw material crushed to less than 0.5 cm was put into the reaction equipment, an appropriate amount of water was added to reach a water content of 50%, and then 2% (w/w) of the solid catalyst according to the embodiment of the present disclosure was added, followed by fully stirring and mixing. The heater was turned on to raise the temperature in the tank to 80° C. After 3 hours of reaction, the water content was reduced to 35% for comparison and analysis of maturity, safety and effectiveness.

(2) Method of “Composting Treatment” to Organic Waste for Making Organic Fertilizer

The traditional composting process to make organic fertilizer uses a commercially available kitchen waste composting bucket with a water filter net drainage valve at the bottom of the bucket and a cover on the top of the bucket. First, the organic waste raw materials were put into the kitchen waste bucket, and an appropriate amount of water was added to reach a water content of 50%. Afterwards, the compost was turned over every two weeks. When the water content was below 45%, an appropriate amount of water was replenished to maintain the water content of the organic material at 50% to facilitate microbial fermentation. The step of turning over was repeated until the organic waste was piled up for 3 months, and then the moisture was reduced to 35% for comparative analysis of maturity, safety and effectiveness.

3. Comparative analysis of the maturity, safety and effectiveness of organic fertilizer products:

### Example 3

Maturity Analysis 1: Biological Analysis of Seed Germination

The biological analysis of seed germination was based on the method proposed by Gariglio et al. (Use of a germination bioassay to test compost maturity of willow (Salix sp.) sawdust, 2002), and the water solution soaking the organic fertilizer made from organic matter after treatment was subject to the germination rate test of crop seeds. According to common knowledge in the art, if immature compost contains phytotoxins or has too high osmotic pressure, seed germination will be inhibited or the seed will be killed. Therefore, seed germination bioanalysis has been widely accepted as one of the indicators for evaluating compost quality. In this study, the seeds of non-heading cabbage (Brassica rapa pure variety) were used for biological analysis. The results are shown in Table 1, which shows that the seed germination percentages of the organic fertilizer products (CHCP, PGCP and KWCP) obtained from the organic wastes of broiler manure (CH), pig manure (PG), kitchen waste and wood chips (KW) subject to the rapid treatment of the solid catalyst of the present disclosure (CHCP, PGCP and KWCP) and the composting treatment separately are all greater than 97.9% (Table 1). According to Brinton (2000) “compost quality standards & guidelines”, it is pointed out that compared with the water control group, the germination rate of 80 to 90% is considered “mature”, and the germination rate reaching 90% or more is considered “very mature” compost. Therefore, the maturity of organic fertilizer products made from solid catalyst quick 3-hour treatment and “composting” 3-month treatment both reach the “very mature” standard.

TABLE 1
Biological analysis of seed germination of organic fertilizers obtained
from catalyst rapid treatment and traditional composting treatment

| | | Germination rate |
|---|---|---|
| | | (%, compared to |
| Treatment items | | control group) |
| Pig manure | Control (H₂O) | 100 |
| | Rapid treatment of solid catalyst | 109.5 |
| | Composting treatment | 99.0 |
| Broiler manure | Control (H₂O) | 100 |
| | Rapid treatment of solid catalyst | 104.4 |
| | Composting treatment | 97.9 |
| Kitchen waste | Control (H₂O) | 100 |
| and wood chips | Rapid treatment of solid catalyst | 105.5 |
| | Composting treatment | 100 |

### Example 4

Maturity Analysis 2: Filter Paper Chromatography Analysis

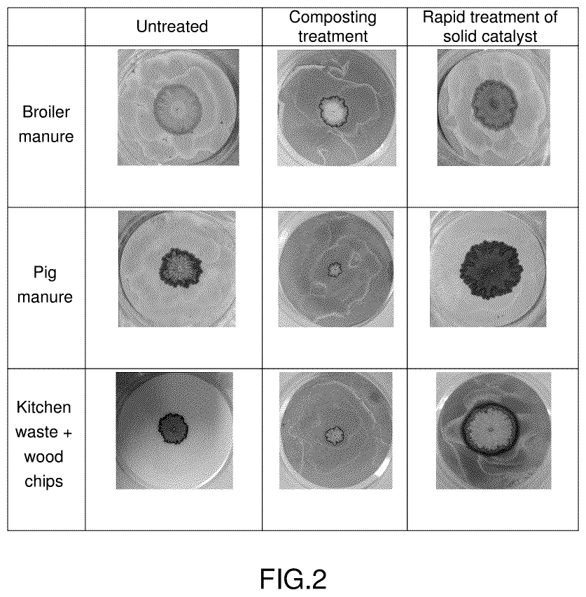

The relatively low-molecular-weight substances produced during the maturing process of organic matter are aggregated into relatively insoluble and macromolecular humic substances, which process is called humification, and humification is one of the indicators of compost maturity. Circular chromatography was used to monitor changes in compost, which can provide clues to the progress of humification and serve as an indicator of organic matter humification (Brinton, Compost Quality Standards and Guidelines, 2010). The circular chromatography explained by Mathur et al. (Determination of compost biomaturity. I. Literature Review, 1993) is based on the fact that humus is formed during composting. The relatively low-molecular-weight humic substances produced initially aggregate into the less soluble, macromolecular mature humic substances, and the size of the diffusion circle is a “quantitative indicator” of humification. The principle of filter paper chromatography is adsorption and partition. The higher the solubility of the substance in 1% NaOH, the higher the mobility. This example showed organic fertilizer products obtained from organic waste raw materials, such as broiler manure, pig manure, kitchen waste and wood chips (1:1 volume ratio), that have been subject to either rapid treatment of the solid catalyst of the present disclosure or the composting treatment. The results of analyzing the components in the alkali extract by filter paper chromatography are shown in FIG. 2. The central positions for the finished organic fertilizers quickly treated with solid catalysts were all dark brown, especially the finished product quickly treated with solid-liquid separation of pig manure being darker, which means that the compounds with high molecular weight have higher content. Therefore, it was judged that the central positions of the filter papers for broiler manure, solid-liquid separation pig manure, kitchen waste and wood chips after composting treatment were whiter and the circles were smaller. From this result, it can be inferred that most of the macromolecular polymers in the sample are decomposed without forming macromolecules after the composting treatment, and the degree of humification is not high.

### Example 5

Safety Index: Salmonella Number Analysis

According to the method of BBLTMXLD plate (BD) media identification proposed by Pollock and Dahlgren (Clinical evaluation of enteric media in the primary isolation of Salmonella and Shigella, 1974), it is shown in Table 2 that Salmonella was not detected in broiler manure, pig manure and kitchen waste added with litter after rapid treatment with solid catalyst, but there was a problem of growing Salmonella in composting treatment, for the “rapid treatment” process comprises the complete sterilization process at 80° C.

TABLE 2
Salmonella number analysis of organic fertilizers
from different treatments of solid catalyst
rapid treatment and traditional composting

| Treatment | | Number of Salmonella |
|---|---|---|
| Code | Treatment | (Log CFU g⁻¹, dry basis) |
| PG | Pig manure-untreated | 4.8 ± 0.0 |
| PGFP | Pig manure-rapid treatment | ND |
| PGCP | Pig manure-composting treatment | 6.3 ± 0.1 |
| CH | Broiler manure-untreated | ND |
| CH-FP | Broiler manure-rapid treatment | ND |
| CHCP | Broiler manure-composting | 5.8 ± 0.0 |
| | treatment | |
| KW | Kitchen waste and litter - | ND |
| | untreated | |
| KWFP | Kitchen waste added with | ND |
| | litter-rapid treatment | |
| KWCP | Kitchen waste added with | 5.3 ± 0.1 |
| | litter-composting treatment | |

### Example 6

Effectiveness Index on Crop Growth: Field Leaf Lettuce Growth Test

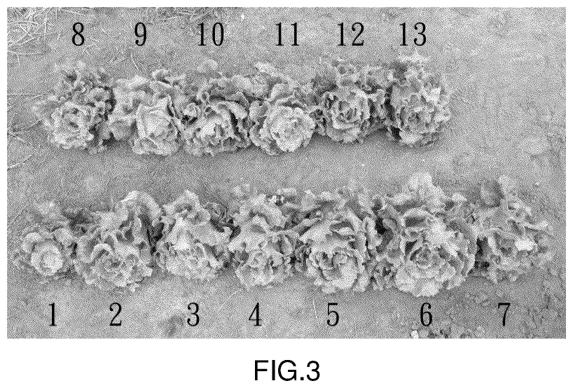

The effectiveness index on crop growth adopts the field verification test of the organic fertilizers obtained by using solid catalyst rapid treatment and composting treatment. Table 3 and FIG. 3 show that solid catalyst rapid treated organic fertilizer and traditional compost have similar effect on field leaf lettuce growth fresh weight and dry weight, indicating that the solid catalyst rapid treatment for 3 hours of the present disclosure can replace the traditional composting method for 3 months. However, the traditional composting method releases carbon dioxide, and the weight of the compost product is reduced by about ⅓ to ½. There is no significant difference in the growth of leaf lettuce observed at 5 metric tons and 10 metric tons per hectare, indicating that field treatment application amount of 5 metric tons per hectare is sufficient for crop growth.

TABLE 3
Fresh weight and dry weight of field leaf lettuce growing for 36 days
and applied with organic fertilizers, which are differently treated
with solid catalyst rapid treatment and traditional compost

| | Treatment | | | | |
|---|---|---|---|---|---|
| | to organic | Fresh weight | | Dry weight | |
| | fertilizer | | Relative | | Relative |
| Treatment | (usage metric | | percentage | | percentage |
| Code | ton/hectare) | Gram | (%) | Gram | (%) |
| 1. Control | Control- | 170.0b* | 100 | 6.45c* | 100 |
| | unttreated (0) | | | | |
| 2. 1 × | Broiler manure- | 440.0a | 259 | 17.66ab | 274 |
| CHFP | rapid treatment(5) | | | | |
| 3. 1 × | Pig manure-rapid | 431.7a | 254 | 16.39ab | 254 |
| PGFP | treatment(5) | | | | |
| 4. 1 × | Kitchen waste- | 401.7a | 236 | 17.46ab | 271 |
| KWFP | rapid treatment(5) | | | | |
| 5. 2 × | Broiler manure- | 473.3a | 278 | 18.96a | 294 |
| CHFP | rapid | | | | |
| | treatment(10) | | | | |
| 6. 2 × | Pig manure-rapid | 468.3a | 275 | 19.18a | 297 |
| PGFP | treatment(10) | | | | |
| 7. 2 × | Kitchen waste- | 411.7a | 242 | 16.73ab | 259 |
| KWFP | rapid | | | | |
| | treatment(10) | | | | |
| 8. 1 × | Broiler manure - | 418.3a | 246 | 16.71ab | 259 |
| CHCP | composting | | | | |
| | treatment(5) | | | | |
| 9. 1 × | Pig manure- | 437.5a | 257 | 17.94ab | 278 |
| PGCP | composting | | | | |
| | treatment(5) | | | | |
| 10. 1 × | Kitchen waste- | 471.7a | 277 | 16.51ab | 256 |
| KWCP | composting | | | | |
| | treatment(5) | | | | |
| 11. 2 × | Broiler manure - | 455.0a | 268 | 16.04ab | 249 |
| CHCP | composting | | | | |
| | treatment(10) | | | | |
| 12. 2 × | Pig manure- | 448.3a | 264 | 18.51ab | 287 |
| PGCP | composting | | | | |
| | treatment(10) | | | | |
| 13. 2 × | Kitchen waste- | 435.0a | 256 | 15.50b | 240 |
| KWCP | composting | | | | |
| | treatment(10) | | | | |

*The same letter in the same column means no significant difference after Duncan's multiple range test (P ≤ 0.05).

The inorganic mineral carrier, biochar carrier and organic carrier of the fixed catalyst listed above only enumerates the applicable general application scope of the catalyst formulation of the present disclosure, and are not limiting. The solid catalyst provided by the disclosure can be applied to rapid treatment of various organic wastes, so that the organic wastes can be made into organic fertilizers and animal feed additives. Various organic wastes include but are not limited to:
1. Livestock manure: laying hen manure, broiler manure, pig manure, cow, horse and sheep manure, other manure, etc.
2. Kitchen waste: raw food waste, cooked food waste, etc.
3. Plants: straw, husks, branches and leaves, bagasse, oil palm fiber, coconut slag fiber, wood chips and mushroom bags, plant dregs, etc.
4. Sludge: alkaline sludge, intermediate acid sludge, etc.
5. Animals: feathers, animal remains and viscera, etc.
6. Organic matter in water areas: including fresh water plants, fresh water algae, etc.
7. Other categories: traditional Chinese medicine residue, microbial fermentation residue and liquid fertilizer, etc.

From the above examples, it can be seen that the solid catalyst composition according to the present disclosure can be used to accelerate the decomposition of organic matter. Solid catalysts are not easily contaminated by bacteria, and the structure and function of the catalyst can be preserved for a long time. Compared with this, liquid catalysts are easily contaminated by bacteria, resulting in damage to the structure and function of the catalyst, that is, the loss of catalyst efficacy. Through the manufacturing method of the solid catalyst composition provided by the present disclosure, it is possible to manufacture a solid catalyst composition that is easy to store, making it more convenient to use. In addition, through the rapid treatment of the solid catalyst composition according to the embodiment of the present disclosure, the organic fertilizer that is better than those obtained by composting for 3 months can be produced within 3 hours.

The above description is only exemplary but not limiting. Any equivalent modification or change made without departing from the spirit and scope of the present invention shall be included in the scope defined by the claims.

What is claimed is:

1. A solid catalyst composition for organic waste treatment, comprising:
a catalyst liquid;
an inorganic mineral carrier;
a biochar carrier; and
an organic carrier,
wherein a weight ratio of the catalyst liquid to a sum of the inorganic mineral carrier, the biochar carrier and the organic carrier is 1:10 to 55, and a weight ratio of the inorganic mineral carrier, the biochar carrier and the organic carrier is 10 to 20:5 to 25:60 to 75.

2. The solid catalyst composition for organic waste treatment of claim 1, wherein the weight ratio of the catalyst liquid to the sum of the inorganic mineral carrier, the biochar carrier and the organic carrier is 1:50.

3. The solid catalyst composition for organic waste treatment of claim 1, wherein the weight ratio of the inorganic mineral carrier, the biochar carrier and the organic carrier is 15:15:70.

4. The solid catalyst composition for organic waste treatment of claim 1, wherein the catalyst liquid comprises at least one of a hydrolase, an oxidoreductase, a transferase, a synthetase, a lyase, a protease, a lipase and a cellulase.

5. The solid catalyst composition for organic waste treatment of claim 1, wherein the inorganic mineral carrier comprises at least one of amorphous minerals, crystalline 1:1 layered minerals and crystalline 2:1 layered minerals.

6. The solid catalyst composition for organic waste treatment of claim 1, wherein the biochar carrier comprises at least one of bamboo charcoal, wood charcoal and activated charcoal.

7. The solid catalyst composition for organic waste treatment of claim 1, wherein the organic carrier comprises at least one of dregs, humic acid, fulvic acid, peat soil powder and starchiness.

8. The solid catalyst composition for organic waste treatment of claim 1, wherein a moisture content of the solid catalyst composition is 10 to 25% by weight.

9. A manufacturing method of a solid catalyst composition for organic waste treatment, comprising:
a catalyst liquid concentration step, which dewaters and concentrates the catalyst liquid to obtain a concentrated catalyst liquid;
an inorganic mineral carrier mixing step, which adds 10 to 20 parts by weight of an inorganic mineral;
a biochar carrier mixing step, which adds 5 to 25 parts by weight of a biochar carrier; and
an organic carrier mixing step, which adds 60 to 75 parts by weight of an organic carrier to obtain a solid catalyst composition.

10. The manufacturing method of claim 9, further comprising a water content control step after the organic carrier mixing step, which controls a weight percentage of water in the solid catalyst composition to 10 to 25%.

11. A use of a solid catalyst composition for organic waste treatment in production of an organic fertilizer, comprising:
providing an organic waste raw material;
mixing the organic waste raw material with the solid catalyst composition of claim 1 to obtain a mixture; and
heating up the mixture to 75 to 85° C. to perform a reaction to obtain the organic fertilizer.

12. The use of claim 11, wherein a weight ratio of the solid catalyst composition to the organic waste raw material is 1:10 to 55.

13. The use of claim 11, wherein the reaction is carried out for 1 to 3.5 hrs.
